(19) United States
(12) Patent Application Publication
(10) Pub. No.: US 2016/0224033 A1
(43) Pub. Date: Aug. 4, 2016

(54) COMPUTER MONITORING SYSTEM, APPARATUS AND METHOD FOR CONTROLLING APPLIANCE OPERATION

(71) Applicant: United Services Automobile Association ("USAA")

(72) Inventor: Jess W. Gingrich, San Antonio, TX (US)

(73) Assignee: United Services Automobile Association ("USAA")

(21) Appl. No.: 15/000,865

(22) Filed: Jan. 19, 2016

Related U.S. Application Data
(60) Provisional application No. 62/104,528, filed on Jan. 16, 2015.

(51) Int. Cl. G05D 7/06; G05B 13/02

(52) U.S. Cl. CPC G05D 7/0635; G05B 13/0265

(57) ABSTRACT

A microcontroller having data acquisition and actuation capabilities is provided for appliance power consumption, water flow, lumens and other measurable aspects of appliance operation. Operation of the appliance is monitored to mitigate abnormal operation.

### CROSS REFERENCE TO RELATED APPLICATIONS

This application claims priority to U.S. Patent Application Ser. No. 62/104,528 filed Jan. 16, 2015 which is incorporated herein by reference in its entirety.

### FIELD OF THE INVENTION

The disclosed embodiments generally relates to an appliance controller, and more particularly, to an integrated electronic control system for controlling an appliance.

### BACKGROUND OF THE INVENTION

With regards to electrical appliances, a primary problem exists with regards to water and electrical damage caused by faulty appliances. A secondary problem is that GFI circuits or main water shut-off valves are often used to turn off power and water to a larger use groups than the faulty appliance component. Thus a tertiary problem is that a device does not currently exists which monitors appliances over time to determine if their fitness is deteriorating and/or provide intelligence on the failing appliance sub-component and how to repair it.

### SUMMARY OF THE INVENTION

The purpose and advantages of the below described illustrated embodiments will be set forth in and apparent from the description that follows. Additional advantages of the illustrated embodiments will be realized and attained by the devices, systems and methods particularly pointed out in the written description and claims hereof, as well as from the appended drawings.

To achieve these and other advantages and in accordance with the purpose of the illustrated embodiments, in one aspect, microcontroller with data acquisition and actuation capabilities is described in which appliance power consumption, water flow, lumens and other measurable aspects of appliance operation are simultaneously measured and caused to direct action to mitigate abnormal operation (e.g. close a valve to stop a water leak, or close a switch breaker for a failing electrical component). An illustrative embodiment preferably includes adaptive “learning” algorithms that feed a decision engine to compensate for changes over time such as identifying drift and estimating the cause of drift for maintenance or other purposes. Thus, the appliance fitness and state of abnormality can be continuously fed to a “Smart” home network for further analysis or decisions.

It is to be appreciated the illustrated embodiments provides adaptive appliance level intelligence regarding of the status of the appliance to mitigate failure modes without disabling the full utility of the appliance. For instance, if there is a water leak in the dishwasher and the water main to the house is turned off, then this is disruptive to all other water uses for the house, such as an occupant may not take a shower or clean the dishes by hand until the leak has been fixed. It is to be further appreciated that illustrative embodiments also diagnose faulty components in an appliance based on the current or power profile of the appliance as a function of time (e.g., when valves switch or pumps engage the current draw changes based on the fitness of the component).

Hence the operation of each appliance is learned and the relationship between appliance inputs (e.g. a distinguishable current profile occurs as a valve opens that provides water flow to the appliance such that the controller knows the current profile that leads the water flow profile and by such intelligence can determine a leak).

Hence, an exemplary object of the illustrated embodiments is to prevent water damage and electrically induced fires.

### BRIEF DESCRIPTION OF THE DRAWINGS

The accompanying appendices and/or drawings illustrate various non-limiting, example, inventive aspects in accordance with the present disclosure:

FIG. 1 illustrates an example communication network used in conjunction with one or more illustrative embodiments;

FIG. 2 illustrates an example computer controlled network device/node used in conjunction with one or more illustrative embodiments;

FIGS. 3 and 4 illustrate an appliance for use with an illustrative embodiment; and

FIG. 5 illustrates a flow diagram depicting operation of an illustrative embodiment.

### DETAILED DESCRIPTION OF CERTAIN EMBODIMENTS

The illustrated embodiments are now described more fully with reference to the accompanying drawings wherein like reference numerals identify similar structural/functional features. The illustrated embodiments are not limited in any way to what is illustrated as the illustrated embodiments described below are merely exemplary, which can be embodied in various forms, as appreciated by one skilled in the art. Therefore, it is to be understood that any structural and functional details disclosed herein are not to be interpreted as limiting, but merely as a basis for the claims and as a representation for teaching one skilled in the art to variously employ the discussed embodiments. Furthermore, the terms and phrases used herein are not intended to be limiting but rather to provide an understandable description of the illustrated embodiments.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the illustrated embodiments, exemplary methods and materials are now described.

It must be noted that as used herein and in the appended claims, the singular forms “a”, “an,” and “the” include plural referents unless the context clearly dictates otherwise. Thus, for example, reference to “a stimulus” includes a plurality of such stimuli and reference to “the signal” includes reference to one or more signals and equivalents thereof known to those skilled in the art, and so forth.

It is to be appreciated the illustrated embodiments discussed below preferably include a software algorithm, program or code residing on computer useable medium having control logic for enabling execution on a machine having a computer processor. The machine typically includes memory storage configured to provide output from execution of the computer algorithm or program.

As used herein, the term “software” is meant to be synonymous with any code or program that can be in a processor of a host computer, regardless of whether the implementation is in hardware, firmware or as a software computer product available on a disc, a memory storage device, or for download from a remote machine. The embodiments described herein include such software to implement the equations, relationships and algorithms described above. One skilled in the art will appreciate further features and advantages of the illustrated embodiments based on the above-described embodiments. Accordingly, the illustrated embodiments are not to be limited by what has been particularly shown and described, except as indicated by the appended claims.

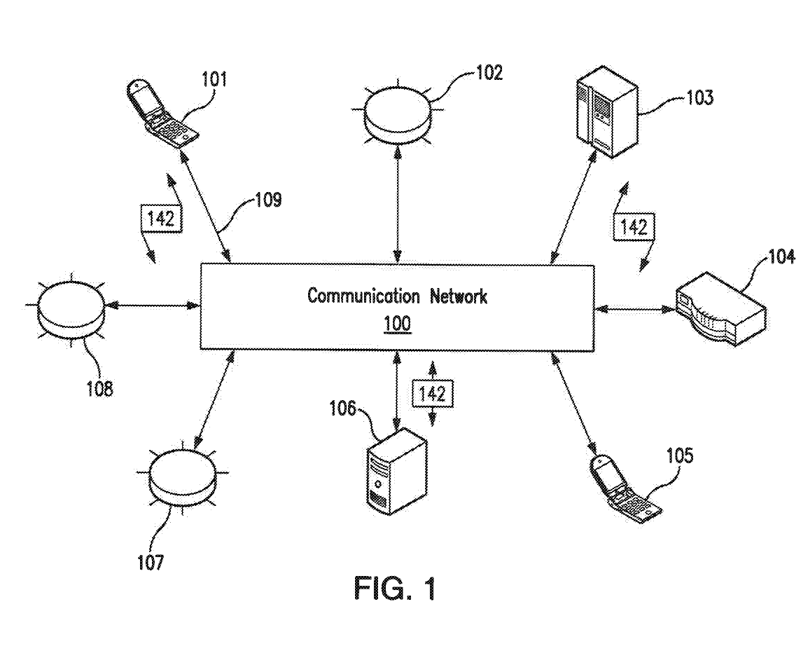

Turning now descriptively to the drawings, in which similar reference characters denote similar elements throughout the several views, FIG. 1 depicts an exemplary communications network 100 in which below illustrated embodiments may be implemented.

It is to be understood a communication network 100 is a geographically distributed collection of nodes interconnected by communication links and segments for transporting data between end nodes, such as personal computers, work stations, smart phone devices, tablets, televisions, sensors and or other devices such as automobiles, etc. Many types of networks are available, with the types ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), synchronous digital hierarchy (SDH) links, or Powerline Communications (PLC), and others.

FIG. 1 is a schematic block diagram of an example communication network 100 illustratively comprising nodes/devices 101-108 (e.g., sensors 102, client computing devices 103, smart phone devices 105, web servers 106, routers 107, switches 108, and the like) interconnected by various methods of communication. For instance, the links 109 may be wired links or may comprise a wireless communication medium, where certain nodes are in communication with other nodes, e.g., based on distance, signal strength, current operational status, location, etc. Moreover, each of the devices can communicate data packets (or frames) 142 with other devices using predefined network communication protocols as will be appreciated by those skilled in the art, such as various wired protocols and wireless protocols etc., where appropriate. In this context, a protocol consists of a set of rules defining how the nodes interact with each other. Those skilled in the art will understand that any number of nodes, devices, links, etc. may be used in the computer network, and that the view shown herein is for simplicity. Also, while the embodiments are shown herein with reference to a general network cloud, the description herein is not so limited, and may be applied to networks that are hardwired.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

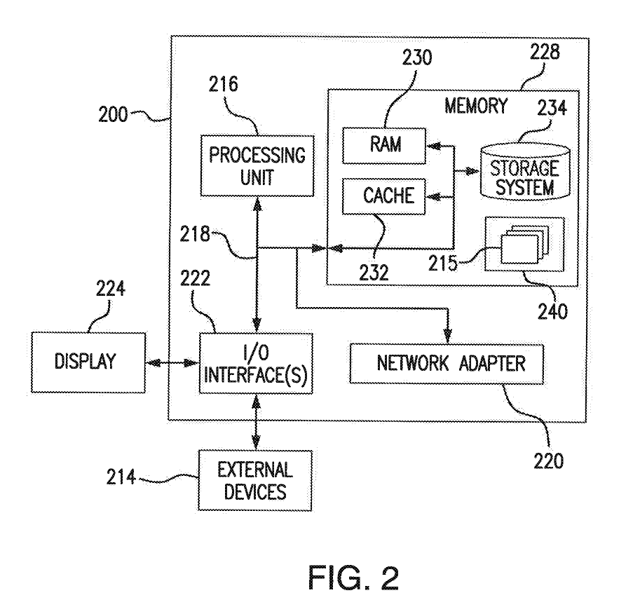

FIG. 2 is a schematic block diagram of an example network computing device 200 (e.g., an appliance controller) (e.g., client computing device 103, server 106, etc.) that may be used (or components thereof) with one or more embodiments described herein, e.g., as one of the nodes shown in the network 100. As explained above, in different embodiments these various devices are configured to communicate with each other in any suitable way, such as, for example, via communication network 100.

Appliance controller device 200 is intended to represent any type of computer system capable of carrying out the teachings of various embodiments of the present invention. Device 200 is only one example of a suitable system and is not intended to suggest any limitation as to the scope of use or functionality of embodiments of the invention described herein. Regardless, controller device 200 is capable of being implemented and/or performing any of the functionality set forth herein.

Computing device 200 is operational with numerous other general purpose or special purpose computing system environments or configurations. Examples of well-known computing systems, environments, and/or configurations that may be suitable for use with computing device 200 include, but are not limited to, micro-controllers, personal computer systems, server computer systems, thin clients, thick clients, hand-held or laptop devices, multiprocessor systems, microprocessor-based systems, set top boxes, programmable consumer electronics, network PCs, minicomputer systems, and distributed data processing environments that include any of the above systems or devices, and the like.

Computing device 200 may be described in the general context of computer system-executable instructions, such as program modules, being executed by a computer system. Generally, program modules may include routines, programs, objects, components, logic, data structures, and so on that perform particular tasks or implement particular abstract data types. Computing device 200 may be practiced in distributed data processing environments where tasks are performed by remote processing devices that are linked through a communications network. In a distributed data processing environment, program modules may be located in both local and remote computer system storage media including memory storage devices.

Device 200 is shown in FIG. 2 in the form of a general-purpose computing device. The components of device 200 may include, but are not limited to, one or more processors or processing units 216, a system memory 228, and a bus 218 that couples various system components including system memory 228 to processor 216.

Bus 218 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computing device 200 typically includes a variety of computer system readable media. Such media may be any available media that is accessible by device 200, and it includes both volatile and non-volatile media, removable and non-removable media.

System memory 228 can include computer system readable media in the form of volatile memory, such as random access memory (RAM) 230 and/or cache memory 232. Computing device 200 may further include other removable/non-removable, volatile/non-volatile computer system storage media. By way of example only, storage system 234 can be provided for reading from and writing to a non-removable, non-volatile magnetic media (not shown and typically called a “hard drive”) and from remote located database (e.g., “cloud” based storage devices). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other media (e.g., a USB storage device) can be provided. In such instances, each can be connected to bus 218 by one or more data media interfaces. As will be further depicted and described below, memory 228 may include at least one program product having a set (e.g., at least one) of program modules that are configured to carry out the functions of embodiments of the invention.

Program/utility 240, having a set (at least one) of program modules 215, such as underwriting module, may be stored in memory 228 by way of example, and not limitation, as well as an operating system, one or more application programs, other program modules, and program data. Each of the operating system, one or more application programs, other program modules, and program data or some combination thereof, may include an implementation of a networking environment. Program modules 215 generally carry out the functions and/or methodologies of embodiments of the invention as described herein.

Device 200 may also communicate with one or more external devices 214 (either via a wired connection or wireless), such as a keyboard, smart phone device, a pointing device, a display 224, etc.; one or more devices that enable a user to interact with computing device 200; and/or any devices (e.g., network card, modem, etc.) that enable computing device 200 to communicate with one or more other computing devices. Such communication can occur via Input/Output (I/O) interfaces 222. Still yet, device 200 can communicate with one or more networks such as a local area network (LAN), a general wide area network (WAN), and/or a public network (e.g., the Internet) via network adapter 220. As depicted, network adapter 220 communicates with the other components of computing device 200 via bus 218. It should be understood that although not shown, other hardware and/or software components could be used in conjunction with device 200. Examples, include, but are not limited to: microcode, device drivers, redundant processing units, external disk drive arrays, RAID systems, tape drives, and data archival storage systems, etc.

FIGS. 1 and 2 are intended to provide a brief, general description of an illustrative and/or suitable exemplary environment in which embodiments of the below described present invention may be implemented. FIGS. 1 and 2 are exemplary of a suitable environment and are not intended to suggest any limitation as to the structure, scope of use, or functionality of an embodiment of the present invention. A particular environment should not be interpreted as having any dependency or requirement relating to any one or combination of components illustrated in an exemplary operating environment. For example, in certain instances, one or more elements of an environment may be deemed not necessary and omitted. In other instances, one or more other elements may be deemed necessary and added.

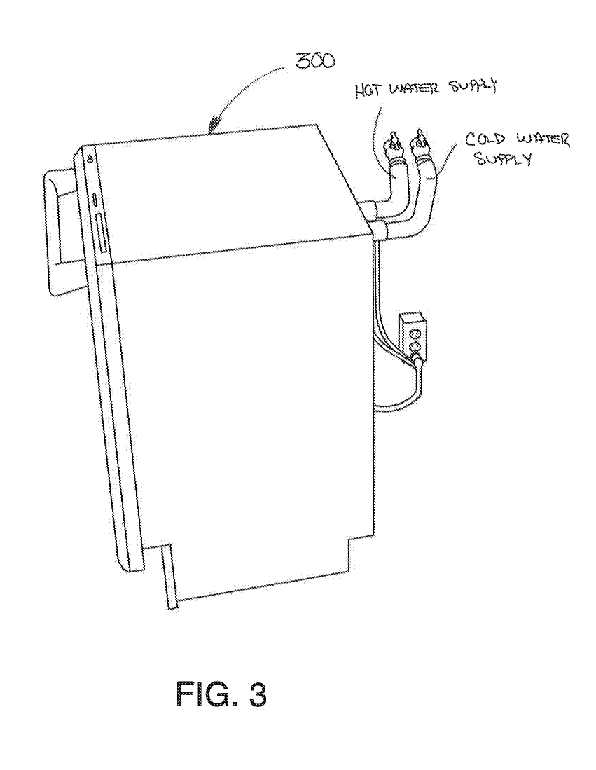

With the exemplary communication network 100 (FIG. 1) and computing device 200 (FIG. 2) being generally shown and discussed above, description of certain illustrated embodiments of the present invention will now be provided. With reference now to FIGS. 3-5 it is to be understood and appreciated significant development and use of “smart home” related technologies have been made and the smart home sector is advancing rapidly. The illustrated embodiments provide a hardware and software control system operational and configured to reduce collateral damage from a failed or faulty appliance and improve the real-time knowledge of the fitness of the appliance. Preferably, one or more illustrated embodiments learn (preferably via a micro-controller device 200) the electrical current and water flow profile for an appliance, e.g. dishwasher, water heater, washing machine, ice maker, electric stovetop, electric oven and can detect abnormalities. It is to be appreciated the one or more illustrated embodiments have utility with many different types of both commercial and residential appliances, including, but not limited to, electric appliances, water flow appliances, gas appliances and any combination thereof.

Abnormalities regarding appliance operation are monitored and detected which preferably triggers warning states based on the learning of the decision engine preferably implemented in a controller device 200. Warning states are configurable to invoke notifications, or direct action to mitigate the abnormality.

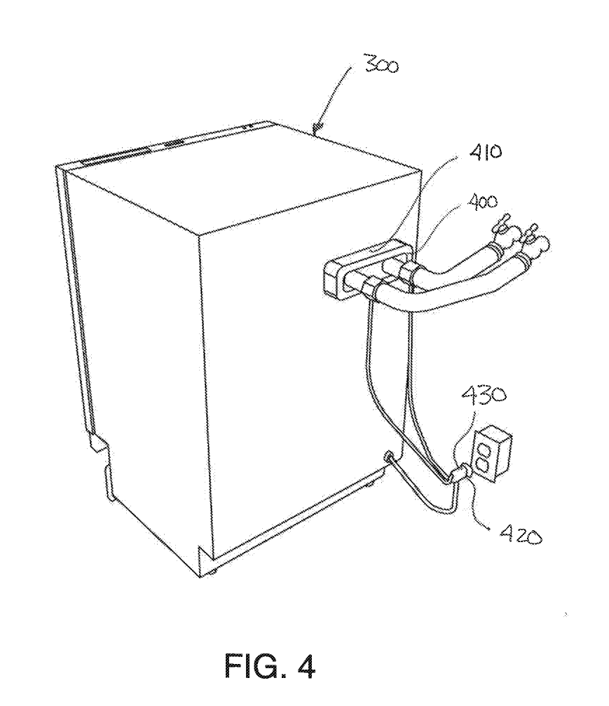

As shown in FIGS. 3 and 4, the illustrated embodiments may preferably include a liquid flow sensor 400, flow shutoff valve 410, electrical current or power meter 420, and microcontroller 430 (and as depicted as 200 in FIG. 2). Communication between the sensors 400 and actuators 410 with the microcontroller 430 can be wired or wireless. The microcontroller 430 preferably contains circuitry to enable analog or digital data acquisition, signal processing, configurable logic, and analog or digital outputs via cable or wireless protocol. It is to be understood and appreciated the microcontroller 430 learns the power profile of the appliance 300 during operation. The water flow profile is also monitored and correlated to the power profile. The adaptive leaning function is designed to interpret changes in appliance settings and the resulting water flow. The temporal relationship between appliance power and water flow is learned enabling intelligence of the controller 430 to detect anomalies in both electric and liquid flow. These anomalies are used to change states in the controller 200. These state changes can trigger notifications to the appliance operator as warnings, trigger action (e.g. shut the water valve 410 to the appliance 300, trip the appliance electrical breaker, and trigger automatic uploads of data to support appliance maintenance, emergency response, or insurance).

The microcontroller 200 can also be connected to a local area network, or Internet, for further information exchange including automatic retrieval of warranty information, stored receipts, and recall notices (Decision Engine).

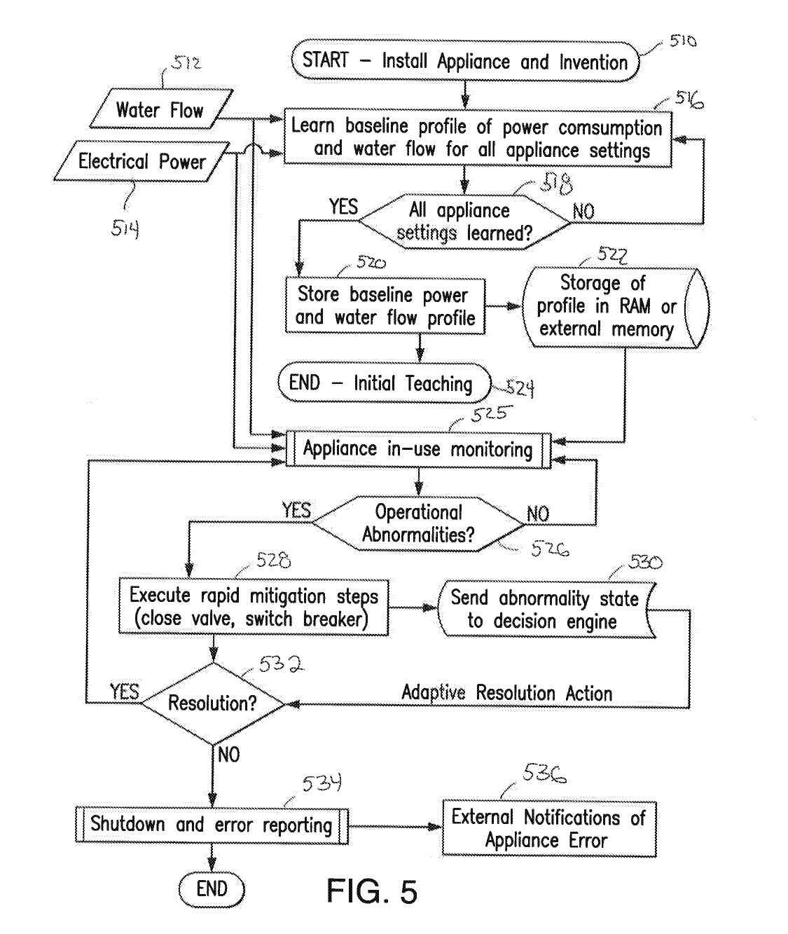

With reference now to FIG. 5, shown is a flow chart demonstrating implementation of the various exemplary embodiments. It is noted that the order of steps shown in FIG. 5 is not necessarily required, so in principle, the various steps may be performed out of the illustrated order. Also certain steps may be skipped, different steps may be added or substituted, or selected steps or groups of steps may be performed in a separate application following the embodiments described herein.

Starting at step 510, if the appliance 300 is not manufactured with the present invention described herein, it is preferably retrofitted with it via the components shown in FIGS. 3 and 4. With water flow 512 and electrical power 514 supplied to the flow sensor 400 and microcontroller 430, the microcontroller 430 is configured to determine the baseline profile of power consumption and water flow for the appliance 300 via predetermined usage patterns of appliance 300 (step 516). The microcontroller 430 then determines if it has determined the baseline settings for the appliance 300 (step 518). If no, it continues to use the water flow and power consumption to determine the baseline setting (step 516). If yes, the microcontroller 430 ceases determination of the baseline setting and will utilize the determined baseline setting for the purposes described at least below (step 524). It is noted, the determined baseline setting is preferable stored in memory associated with the microcontroller 430 (e.g., RAM or external memory) (step 522).

With the microcontroller 430 continuing to monitor the water flow and power consumption for appliance 300 (step 525), it preferably utilizes this data to determine abnormalities from the aforesaid determined baseline setting (step 526). Detected “abnormalities” are preferably one or more predetermined deviations from the water flow and/or power consumption contained in the determined baseline setting during operation of the appliance 300. For instance, is the appliance using too little or too much water and/or too little or too much electrical power. If no, the microcontroller continues to monitor the aforesaid operation of the appliance 300 (step 525). If yes (abnormal operation of appliance 300 is detected), the microcontroller 430 preferably initiates mitigation actions, preferably contingent upon the detected operation abnormalities to mitigate the detected abnormality situation (step 528). For instance, this can include, but is not limited to, closing one or more water valves upon detection of abnormal water flow, tripping an electrical breaker (or otherwise ceasing electrical power supply) upon detection of abnormal electrical power consumption, etc. After mitigation, a decision is then made (preferably in a decision engine module of microcontroller 430) as to whether the aforesaid mitigation actions returned operation of the appliance 300 to within the operating parameters prescribed by the aforesaid determined baseline operation of the appliance 300 (steps 530, 532). If yes, operation of monitoring of appliance 300 continues (via step 526). If no, microcontroller 430 preferably causes operation of the appliance to cease while also preferably providing error reporting notification (step 534), which notification may be send external of the appliance (step 536).

With certain illustrated embodiments described above, it is to be appreciated that various non-limiting embodiments described herein may be used separately, combined or selectively combined for specific applications. Further, some of the various features of the above non-limiting embodiments may be used without the corresponding use of other described features. The foregoing description should therefore be considered as merely illustrative of the principles, teachings and exemplary embodiments of this invention, and not in limitation thereof.

It is to be understood that the above-described arrangements are only illustrative of the application of the principles of the illustrated embodiments. Numerous modifications and alternative arrangements may be devised by those skilled in the art without departing from the scope of the illustrated embodiments, and the appended claims are intended to cover such modifications and arrangements.

What is claimed is:

1. A computer control system for controlling operation of an appliance, comprising:
a memory configured to store instructions;
a processor disposed in communication with said memory, wherein said processor upon execution of the instructions is configured to:
perform an initiation mode to determine a baseline operating profile for the appliance which includes:
receiving electrical power and water consumption rates consumed by the appliance for a certain time period to determine a baseline operating profile for the appliance;
perform a monitoring mode, subsequent to determination of the baseline operating profile, which includes:
receiving real-time electrical power and water consumption rates consumed by the appliance to determine a real-time operating profile for the appliance;
comparing the real-time operating profile with the baseline operating profile to determine a deviation between the real-time operating profile with the baseline operating profile; and
enable operational changes to the appliance when the determined deviation exceeds a threshold value.

2. The computer control system as recited in claim 1 wherein the enabled operational changes include causing change in electrical power supplied to the appliance.

3. The computer control system as recited in claim 2 wherein change of the electrical power supplied to the appliance includes prevention thereof.

4. The computer control system as recited in claim 1 wherein the enabled operational changes include causing change in water flow supplied to the appliance.

5. The computer control system as recited in claim 2 wherein change of the water flow supplied to the appliance includes prevention thereof.

6. The computer control system as recited in claim 1 wherein the enabled operational changes include providing notification to a user of the appliance regarding abnormal operation of the appliance.

7. The computer control system as recited in claim 1 wherein the processor upon execution of the instructions is further configured to provide a resolution mode when the determined deviation exceeds a threshold value wherein the resolution mode includes attempted continuing operation of the appliance by adjusting at least one operating parameter of the appliance such that the determined deviation no longer exceeds a threshold value.

8. The computer control system as recited in 1 further including an electrical water flow sensor valve.

9. The computer control system as recited in 9 wherein the electrical water flow sensor valve is connected in line with a main water valve.

10. The computer control system as recited in claim 1 further including a microcontroller device coupled intermediate the appliance and an electrical power source.

11. The computer control system as recited in claim 10 wherein the microcontroller provides an electrical power meter.

12. The computer control system as recited in claim 10 wherein the microcontroller provides a water flow meter.

13. The computer control system as recited in claim 10 wherein the microcontroller provides a valve controller.

14. The computer control system as recited in claim 10 wherein the microcontroller couples to a communications network.

15. The computer control system as recited in claim 10 wherein the microcontroller is configured to receive data relating to at least one of warranty information, stored receipts and recall notices relating to the appliance.

16. A computer control system for controlling operation of an appliance, comprising:
a memory configured to store instructions;
a processor disposed in communication with said memory, wherein said processor upon execution of the instructions is configured to:
perform an initiation mode to determine a baseline operating profile for the appliance which includes:
receiving an electrical power rate consumed by the appliance for a certain time period to determine a baseline operating profile for the appliance;
perform a monitoring mode, subsequent to determination of the baseline operating profile, which includes:
receiving real-time electrical power rate consummation by the appliance to determine a real-time operating profile for the appliance;
comparing the real-time operating profile with the baseline operating profile to determine a deviation between the real-time operating profile with the baseline operating profile; and
enable operational changes to the appliance when the determined deviation exceeds a threshold value.

17. A computer control system for controlling operation of an appliance, comprising:
a memory configured to store instructions;
a processor disposed in communication with said memory, wherein said processor upon execution of the instructions is configured to:
perform an initiation mode to determine a baseline operating profile for the appliance which includes:
receiving a water flow rate consumed by the appliance for a certain time period to determine a baseline operating profile for the appliance;
perform a monitoring mode, subsequent to determination of the baseline operating profile, which includes:
receiving real-time water rate consummation by the appliance to determine a real-time operating profile for the appliance;
comparing the real-time operating profile with the baseline operating profile to determine a deviation between the real-time operating profile with the baseline operating profile; and
enable operational changes to the appliance when the determined deviation exceeds a threshold value.

18. A computer control system for controlling operation of an appliance, comprising:
a memory configured to store instructions;
a processor disposed in communication with said memory, wherein said processor upon execution of the instructions is configured to:
perform an initiation mode to determine a baseline operating profile for the appliance which includes:
receiving a gas flow rate consumed by the appliance for a certain time period to determine a baseline operating profile for the appliance;
perform a monitoring mode, subsequent to determination of the baseline operating profile, which includes:
receiving real-time gas rate consummation by the appliance to determine a real-time operating profile for the appliance;
comparing the real-time operating profile with the baseline operating profile to determine a deviation between the real-time operating profile with the baseline operating profile; and
enable operational changes to the appliance when the determined deviation exceeds a threshold value.
